(19) United States
(12) Patent Application Publication
(10) Pub. No.: US 2021/0185764 A1
(43) Pub. Date: Jun. 17, 2021

(54) ELECTRIC HEATING DEVICE AND METHOD FOR OPERATING THE ELECTRIC HEATING DEVICE

(71) Applicant: MAHLE International GmbH, Stuttgart (DE)

(72) Inventors: Helmut GANDER, Bietigheim-Bissingen (DE); Christoph DAHM, Kernen i.R. (DE)

(73) Assignee: MAHLE International GmbH, Stuttgart (DE)

(21) Appl. No.: 17/123,940

(22) Filed: Dec. 16, 2020

(30) Foreign Application Priority Data
Dec. 17, 2019 (DE) 10 2019 219 915.1
Jan. 31, 2020 (DE) 10 2020 000 642.6

(51) Int. Cl. H05B 3/00; H05B 1/02

(52) U.S. Cl. CPC H05B 3/0019; H05B 1/0202; H05B 2203/035; H05B 2203/011; H05B 2203/007

(57) ABSTRACT

An electric heating device having a multiplicity of electric heating elements, wherein the respective electric heating element has a first electric contact element and a second electric contact element and at least one heater, wherein the first and second electric contact elements achieve electrical contacting of the at least one electric heater, additionally having a first voltage connection element and a second voltage connection element, additionally having first switching elements and having second switching elements, wherein pairs of two electric heating elements are each wired such that two first electric contact elements in each case of the two electric heating elements can be switchably connected to the first voltage connection element by one of the first switching elements and one of the second contact elements in each case of the pairs can be switchably connected to the second voltage connection element by means of a second switching element.

This nonprovisional application claims priority under 35 U.S.C. § 119(a) to German Patent Application No. 10 2019 219 915.1, which was filed in Germany on Dec. 17, 2019 and to German Patent Application No. 10 2020 000 642.6 which was filed in Germany on Jan. 31, 2020, and which are both are herein incorporated by reference.

### BACKGROUND OF THE INVENTION

### Field of the Invention

The present invention relates to an electric heating device and a method for operating an electric heating device, in particular as an electric heating device for a motor vehicle, in particular as an electric heater or as an auxiliary electric heater.

### Description of the Background Art

Diverse electric heating devices are known in motor vehicles. Thus, for example, electric heating devices in the form of air heaters or auxiliary air heaters have become known by which the air is heated for passenger compartment heating. Water heaters are also known, which heat water in a water circuit, wherein the water is used in turn for heating of the air for the passenger compartment. Fuel heaters, oil heaters, etc. are also known.

In the case of the electric heating devices, it is known that a number of heating elements are provided, wherein the heating elements have at least one heater and a contact and, if applicable, electrical insulation, so that the at least one heater is electrically arranged between the contact in order to electrically contact the at least one heater and be able to connect to a voltage difference.

For this purpose, a power switch arrangement is provided, by which means the heating elements can be connected to or disconnected from the voltage difference in order to achieve a flow of current and a heating of the heating elements on the one hand or on the other hand to prevent the flow of current in order to thereby also prevent the heating of the heating elements.

In this context, it is known in the prior art that two heating elements at a time are electrically connected in parallel and the pairs of heating elements are connected to a first electrical potential at one of their contact, and are connected through a power switch to a second electrical potential at their other contact. Now, if the power switch of a pair of heating elements is closed, then an electric current flows through the two heating elements of the pair of heating elements and they heat up.

In the prior art, a multiplicity of such pairs of heating elements are provided that can be controlled in each case through a power switch. Thus, a total of half as many power switches as heating elements is provided in this design, because the heating elements are wired in pairs in each case and are controlled by one power switch for each pair.

In order to control the desired heat output of the heating device, the power switches are controlled by means of PWM control. It is also known that the individual power switches of the heating element pairs are activated in a time-shifted manner in order to even out the current flow across all heating elements over time and to avoid current peaks.

However, this still has the disadvantage that the maximum current flowing in each case is relatively high due to the fact that the heating elements are wired in pairs.

If, in order to avoid the above disadvantages, the number of power switches is doubled so as to provide one power switch for each heating element in order to refine control, the costs are increased considerably.

### SUMMARY OF THE INVENTION

It is therefore an object of the present invention to provide a method for operating an electric heating device via which simplified control is achieved together with a reduction in current peaks, wherein the costs for the heating device nevertheless do not increase substantially. The object is also to create a heating device suitable for this purpose at low cost.

An exemplary embodiment of the invention relates to an electric heating device having a multiplicity of electric heating elements, wherein the respective electric heating element has a first electric contact element and a second electric contact element and at least one heater, wherein the first and second electric contact elements achieve electrical contacting of the at least one electric heater; additionally having a first voltage connection element and a second voltage connection element; additionally having first switching elements and having second switching elements, wherein pairs of two electric heating elements are each wired such that two first electric contact elements in each case of the two electric heating elements can be switchably connected to the first voltage connection element by one of the first switching elements and one of the second contact elements in each case of the pairs can be switchably connected to the second voltage connection element by means of a second switching element, and the other second contact element in each case of the pair can be switchably connected thereto by a different second switching element. This achieves the result that all heating elements can be individually controlled through the actuation of the first switching elements and of the second switching elements, for example for PWM control, without requiring a separate switching element for each electric heating element.

It is also advantageous when each first heating element of the two heating elements of the pairs can be switchably connected by its second contact element through one second switching element to the second voltage connection element and each second heating element of the two heating elements of the pairs can be switchably connected by its second contact element through the other second switching element to the second voltage connection element. This likewise advantageously achieves the result that all heating elements can be individually controlled through the actuation of the first switching elements and of the second switching elements, for example for PWM control, without requiring a separate switching element for each electric heating element.

A third heating element can be associated with the pairs having two electric heating elements, so that triplets of heating elements are present, wherein the triplets of three electric heating elements are each wired such that three first electric contact elements of the three electric heating elements in each case can be switchably connected to the first voltage connection element by one of the first switching elements, and one of the second contact elements of the triplets in each case can be switchably connected to the second voltage connection element by means of a first second switching element, and a second second contact element of the triplets in each case can be switchably connected thereto by a second second switching element, and a third second contact element of the triplets in each case can be switchably connected thereto by a third second switching element. As a result, an electric heating device can be created that is designed with triplets of electric heating elements, wherein each triplet is individually switchable in each case while the number of switching elements nevertheless remains low.

It is also advantageous in this design when each first heating element of the three heating elements of the triplets can be switchably connected by its second contact element through one second switching element to the second voltage connection element, and each second heating element of the three heating elements of the triplets can be switchably connected by its second contact element through the second second switching element to the second voltage connection element and each third heating element of the three heating elements of the triplets can be switchably connected by its second contact element through the third second switching element to the second voltage connection element.

N−2 heating elements can be associated with the pairs having two electric heating elements, so that N-tuples of heating elements are present, wherein the N-tuples of N electric heating elements are each wired such that N first electric contact elements of the N electric heating elements in each case can be switchably connected by one of the first switching elements to the first voltage connection element, and one first second contact element of the N-tuples in each case can be switchably connected to the second voltage connection element by means of a first second switching element, and a second second contact element of the N-tuples in each case can be switchably connected thereto by a second second switching element, and a third second contact element of the N-tuples in each case can be switchably connected thereto by a third second switching element, and an nth second contact element of the N-tuples in each case can be switchably connected thereto by an nth second switching element, and an N−1th second contact element of the N-tuples in each case can be switchably connected thereto by means of an N−1th second switching element, and an Nth second contact element of the N-tuples in each case can be switchably connected thereto by means of an Nth second switching element, wherein N is a natural number that is greater than or equal to 2 and n is a natural number from 4 to N−2.

Each first heating element of the N heating elements of the N-tuples can be switchably connected by its second contact element through the first second switching element to the second voltage connection element, and each second heating element of the N heating elements of the N-tuples can be switchably connected by its second contact element through the second second switching element to the second voltage connection element, and each third heating element of the N heating elements of the N-tuples can be switchably connected by its second contact element through the third second switching element to the second voltage connection element, and each nth heating element of the N heating elements of the N-tuples can be switchably connected by its second contact element through the nth second contact element to the second voltage connection element, and each N−1th heating element of the N heating elements of the N-tuples can be switchably connected by its second contact element through the N−1th second switching element to the second voltage connection element, and each Nth heating element of the N heating elements of the N-tuples can be switchably connected by its second contact element through the Nth second switching element to the second voltage connection element, wherein N is a natural number that is greater than or equal to 2 and n is a natural number from 4 to N−2.

The electric switching elements can be electronically controllable switching elements. In this way, suitable electronic control can be realized, such as can be used for a motor vehicle, for example.

It is especially advantageous when the electric switching elements are electronically controllable power switching elements. In this way, a compact electronic control unit can advantageously be created with which even high currents can be appropriately controlled, in particular for applications including low-voltage and high-voltage applications. In this context, a high-voltage application is operated at voltages greater than 60 V.

The electric switching elements can be part of an electronic control unit that is a component of the electric heating device. In this case, the integration of the electronic control unit in the electric heating device is especially space-saving and also facilitates assembly.

It is also advantageous when radiator elements are provided and are arranged in thermal contact with the electric heating elements for heat transfer from the electric heating elements to a medium flowing around and/or through the radiator elements. This achieves the result that good heat transmission takes place to a medium that is to be heated. The radiator elements in this case can advantageously be corrugated fins or stacked fins, etc.

It is especially advantageous when the radiator elements are arranged such that at least one radiator element is arranged adjacent to one of the electric heating elements in each case. As a result, the heat transmission can advantageously take place from all electric heating elements to the medium that is to be heated.

Further, a method for operating an electric heating device is provided, wherein the first switching elements and the second switching elements are selectively controlled in order to heat the electric heating elements in a controlled manner.

In this case it is also advantageous when the first switching elements and/or the second switching elements are controlled in order to heat each heating element in an individually controlled manner.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an electric heating device according to the invention,

FIG. 2 shows a graph for explaining the invention; and

FIG. 3 shows a schematic representation of another electric heating device according to the invention.

### DETAILED DESCRIPTION

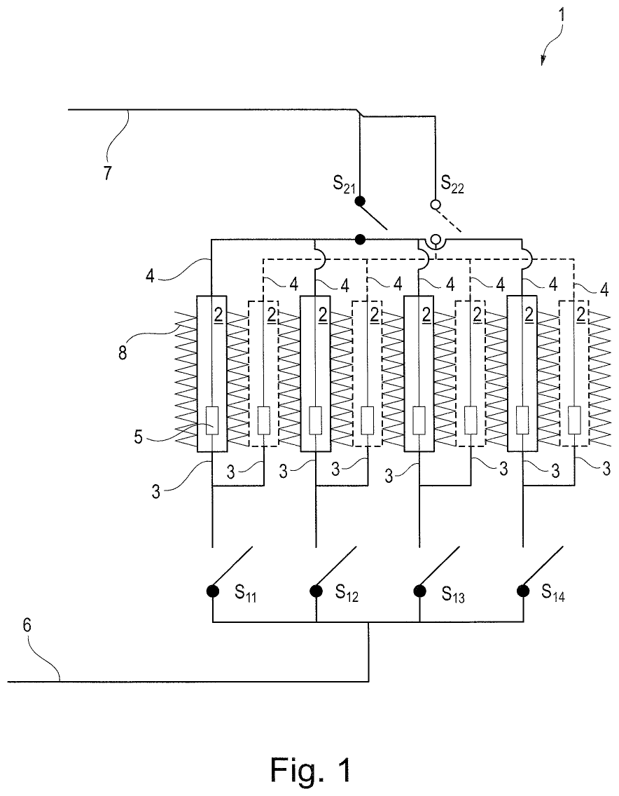

FIG. 1 shows a schematic representation of an electric heating device 1. The electric heating device 1 can preferably be used as a heater or as an auxiliary heater for a motor vehicle, including for an electric vehicle, in particular. The electric heating device 1 can be intended for heating air, for example for the motor vehicle interior.

The electric heating device 1 has a multiplicity of electric heating elements 2. These heating elements 2 can be arranged in a plane of a heating grid, for example, or otherwise.

Each one of the electric heating elements 2 in this design has a first electric contact element 3, a second electric contact element 4, and at least one heater 5. Multiple such heater 5 can also be provided in this design. The one or more heater 5 is or are contacted in parallel by the first contact element 3 and the second contact element 4, depending on how many heater 5 are provided. The heater 5 can be designed as PTC elements, for example. Alternatively, they can also be designed as resistance elements with an NTC characteristic.

The first and second electric contact elements 3, 4 in this design achieve electrical contacting of the at least one electric heater 5 or of the multiple electric heater 5 of a heating element 2.

Furthermore, the electric heating device 1 has a first voltage connection element 6 and a second voltage connection element 7 that serve to connect the electric heating element 2 to an external voltage source. In this design, the first voltage connection element 6 is connected to a first electric potential and the second voltage connection element 7 is connected to a second electric potential so that the electric heating device 1 is connected to a potential difference.

Furthermore, the electric heating device 1 has first switching elements S11, S12, S13, and S14 as well as second switching elements S21 and S22. The first switching elements S11 to S14 electrically connect the heating elements 2 to the first voltage connection element 6, and the second switching elements S21 and S22 electrically connect the heating elements 2 to the second voltage connection element 7. The type of electrical connection is explained below.

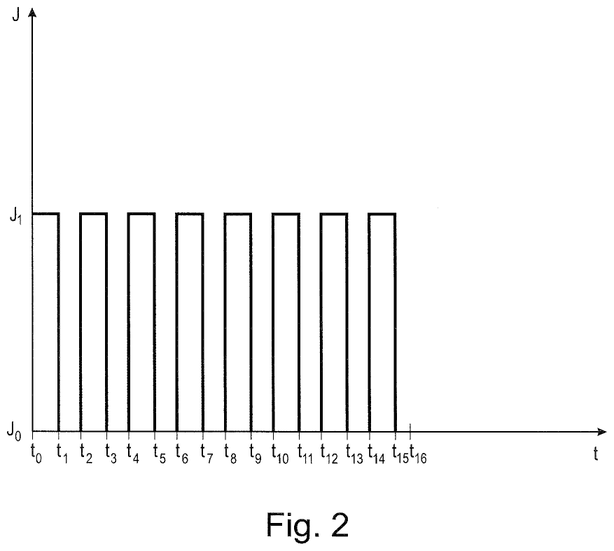

FIG. 2 shows that pairs of two electric heating elements 2 are each wired such that the two first electric contact elements 3 in each case of the two electric heating elements 2 of a given pair can be switchably connected to the first voltage connection element 6 by one of the first switching elements S11, S12, S13, S14, and, additionally, one of the second contact elements 4 in each case of the pairs can be switchably connected to the second voltage connection element 7 by means of a second switching element S21 and the other second contact element 4 in each case of the pair can be switchably connected thereto by a different second switching element S22.

This achieves the result that all individual heating elements 2 can be individually powered, for example in PWM control, through appropriate actuation and opening or closing of the individual switching elements of the individual switching elements S11 to S22.

For this purpose, each first heating element 2 of the two heating elements 2 of the pairs can be switchably connected by its second contact element 4 through one second switching element S21 to the second voltage connection element 7, and each second heating element 2 of the two heating elements 2 of the pairs can be switchably connected by its second contact element 4 through the other second switching element S22 to the second voltage connection element 7, for example.

The electric switching elements S11 to S22 can be electronically controllable switching elements, for example electronically controllable power switching elements.

According to one advantageous exemplary embodiment, the electric switching elements S11 to S22 are part of an electronic control unit that is a component of the electric heating device 1.

In the case of the electric heating device 1, it is additionally advantageous when radiator elements 8 are provided that are arranged in thermal contact with the electric heating elements 2 in order to promote the heat transfer from the electric heating elements 2 to a medium flowing around and/or through the radiator elements 8.

The radiator elements 8 are arranged such that at least one radiator element 8 is arranged adjacent to one of the electric heating elements 2 in each case, as FIG. 1 shows by way of example.

Alternatively, the radiator elements 8 can also be arranged in another way and/or additional elements for airflow control can also be provided.

An electric heating device 1 shown in FIG. 1 permits a method for operating an electric heating device 1 in such a manner that the first switching elements S11 to S14 and the second switching elements S21 and S22 are selectively controlled in order to heat the electric heating elements 2 in a controlled manner. In this case the respective switching elements S11 to S22 are controlled together or in alternation or singly in such a manner that individual heating elements 2 are selectively heated, for example through PWM control of the current flowing through the heater 5. Thus, sequential heating of the heating elements 2 can be carried out by means of PWM control, for example.

Accordingly, the first switching elements S11 to S14 and/or the second switching elements S21 and S22 are controlled in order to heat each heating element in an individually controlled manner.

FIG. 2 shows a graph for explaining the control method. The current flow I is shown here as a function of time t.

From time t0 to t1, switch S11 is closed and switches S12 to S14 are open. Furthermore, switch S21 is closed and switch S22 is open. A current thus flows through the first heating element 2 from the left as seen in FIG. 1. From t1 to t2, switch S11 and/or switch S21 is also open, so no current flows.

From time t2 to t3, switch S11 is closed and switches S12 to S14 are open. Furthermore, switch S22 is closed and switch S21 is open. A current thus flows through the second heating element 2 from the left as seen in FIG. 1. From t3 to t4, switch S11 and/or switch S22 is also open, so no current flows.

From time t4 to t5, switch S12 is closed and switches S11, S13, and S14 are open. Furthermore, switch S21 is closed and switch S22 is open. A current thus flows through the third heating element 2 from the left as seen in FIG. 1. From t5 to t6, switch S12 and/or switch S21 is also open, so no current flows.

From time t6 to t7, switch S12 is closed and switches S11, S13, and S14 are open. Furthermore, switch S22 is closed and switch S21 is open. A current thus flows through the fourth heating element 2 from the left as seen in FIG. 1. From t7 to t8, switch S12 and/or switch S22 is also open, so no current flows.

From time t8 to t9, switch S13 is closed and switches S11, S12, and S14 are open. Furthermore, switch S21 is closed and switch S22 is open. A current thus flows through the fifth heating element 2 from the left as seen in FIG. 1. From t9 to t10, switch S13 and/or switch S21 is also open, so no current flows.

From time t10 to t11, switch S13 is closed and switches S11, S12, and S14 are open. Furthermore, switch S22 is closed and switch S21 is open. A current thus flows through the sixth heating element 2 from the left as seen in FIG. 1. From t11 to t12, switch S13 and/or switch S22 is also open, so no current flows.

From time t12 to t13, switch S14 is closed and switches S11, S12, and S13 are open. Furthermore, switch S21 is closed and switch S22 is open. A current thus flows through the seventh heating element 2 from the left as seen in FIG. 1. From t13 to t14, switch S14 and/or switch S21 is also open, so no current flows.

From time t14 to t15, switch S14 is closed and switches S11, S12, and S13 are open. Furthermore, switch S22 is closed and switch S21 is open. A current thus flows through the eighth heating element 2 from the left as seen in FIG. 1. From t15 to t16, switch S14 and/or switch S22 is also open, so no current flows.

In this way, all heating elements 2 can be controlled. It is then possible to implement PWM control, for example, over the time of controlled current flow.

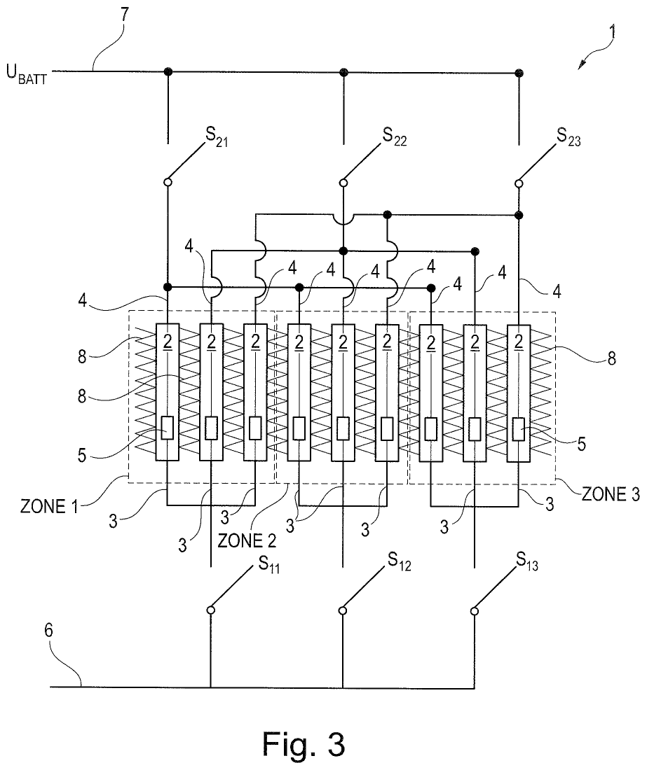

FIG. 3 shows a schematic representation of another electric heating device 1 according to the invention. The electric heating device 1 can preferably be used as a heater or as an auxiliary heater for a motor vehicle, including for an electric vehicle, in particular. The electric heating device 1 can be intended for heating air, for example for the motor vehicle interior.

The electric heating device 1 has a multiplicity of electric heating elements 2. These heating elements 2 can likewise be arranged in a plane of a heating grid, for example, or otherwise.

Each one of the electric heating elements 2 in this design has a first electric contact element 3, a second electric contact element 4, and at least one heater 5. Multiple such heater 5 can also be provided in this design. The one or more heater 5 is or are contacted in parallel by the first contact element 3 and the second contact element 4, depending on how many heater 5 are provided. The heater 5 can be designed as PTC elements, for example. Alternatively, they can also be designed as resistance elements with an NTC characteristic.

The first and second electric contact elements 3, 4 in this design achieve electrical contacting of the at least one electric heater 5 or of the multiple electric heater 5 of a heating element 2.

Furthermore, the electric heating device 1 has a first voltage connection element 6 and a second voltage connection element 7 that serve to connect the respective electric heating element 2 to an external voltage source. In this design, the first voltage connection element 6 is connected to a first electric potential and the second voltage connection element 7 is connected to a second electric potential so that the electric heating device 1 is connected to a potential difference, for example to a battery.

Furthermore, the electric heating device 1 has first switching elements S11, S12, and S13 as well as second switching elements S21, S22, and S23. The first switching elements S11 to S13 electrically connect the heating elements 2 to the first voltage connection element 6 and the second switching elements S21, S22, and S23 electrically connect the heating elements 2 to the second voltage connection element 7. The type of electrical connection is explained below.

For this purpose, the first electric contact elements 3 of the electric heating elements 2 of first triplets are connected in each case through the first switching element S11 to the first voltage connection element 6. Furthermore, the first electric contact elements 3 of the electric heating elements 2 of second triplets are connected in each case through the first switching element S12 to the first voltage connection element 6. Furthermore, the first electric contact elements 3 of the electric heating elements 2 of third triplets are connected in each case through the first switching element S13 to the first voltage connection element 6.

Control of the electric heating device 1 is carried out in such a manner that all individual heating elements 2 can be individually powered, for example in PWM control, through appropriate actuation and opening or closing of the individual switching elements S11 to S23.

For this purpose, for example, each first heating element 2 of the three heating elements 2 of the triplets of zone 1, zone 2, and zone 3 can be switchably connected by its second contact element 4 through one second switching element S21 to the second voltage connection element 7, and each second heating element 2 of the three heating elements 2 of the triplets can be switchably connected by its second contact element 4 through the second second switching element S22 to the second voltage connection element 7. Also, each third heating element 2 of the three heating elements 2 of the triplets can be switchably connected by its second contact element 4 through a third second switching element S23 to the second voltage connection element 7.

According to one advantageous exemplary embodiment, the electric switching elements S11 to S23 are electronically controllable switching elements, for example electronically controllable power switching elements.

According to one advantageous exemplary embodiment, the electric switching elements S11 to S23 are part of an electronic control unit that is a component of the electric heating device 1.

In the case of the electric heating device 1, it is additionally advantageous when radiator elements 8 are provided that are arranged in thermal contact with the electric heating elements 2 in order to promote heat transfer from the electric heating elements 2 to a medium flowing around and/or through the radiator elements 8.

According to one exemplary embodiment, the radiator elements 8 are arranged such that at least one radiator element 8 is arranged adjacent to one of the electric heating elements 2 in each case, as FIG. 3 shows by way of example. Alternatively, the radiator elements 8 can also be arranged in another way and/or additional elements for airflow control can also be provided.

An electric heating device 1 shown in FIG. 3 permits a method for operating an electric heating device 1 in such a manner that the first switching elements S11 to S13 and the second switching elements S21, S22, and S23 are selectively controlled in order to heat the electric heating elements 2 in a controlled manner. In this case the respective switching elements S11 to S23 are controlled together or in alternation or singly in such a manner that individual heating elements 2 are selectively heated, for example through PWM control of the current flowing through the heater 5. Thus, sequential heating of the heating elements 2 can be carried out by means of PWM control, for example.

Accordingly, the first switching elements S11 to S13 and/or the second switching elements S21, S22, and S23 are controlled in order to heat each heating element in an individually controlled manner.

The electric heating device 1 from FIG. 3 can also be understood such that a third heating element 2 is associated with each of the pairs having two electric heating elements 2 so that triplets of electric heating elements 2 are present, wherein the triplets of three electric heating elements 2 are each wired such that three first electric contact elements 3 of the three electric heating elements 2 in each case can be switchably connected through one of the first switching elements S11, S12, S13 to the first voltage connection element 6, and one of the second contact elements 4 of the triplets in each case can be switchably connected to the second voltage connection element 7 by means of a first second switching element S21, and a second second contact element 4 of the triplets in each case can be switchably connected thereto by a second second switching element S22, and a third second contact element 4 of the triplets in each case can be switchably connected thereto by a third second switching element S23.

Accordingly, each first heating element 2 of the three heating elements 2 of the triplets can be switchably connected by its second contact element 4 through one second switching element S21 to the second voltage connection element 7, and each second heating element 2 of the three heating elements 2 of the triplets can be switchably connected by its second contact element 4 through the second second switching element S22 to the second voltage connection element 7, and each third heating element 2 of the three heating elements 2 of the triplets can be switchably connected by its second contact element 4 through the third second switching element S23 to the second voltage connection element 7.

In the most general sense, this can also be phrased such that N−2 heating elements are associated with the pairs having two electric heating elements, so that N-tuples of heating elements are present, wherein the N-tuples of N electric heating elements 2 are each wired such that N first electric contact elements 3 of the N electric heating elements 2 in each case can be switchably connected through one of the first switching elements S11, S12, S13, S14, . . . to the first voltage connection element 6, and one first second contact element 4 of the N-tuples in each case can be switchably connected to the second voltage connection element 7 by means of a first second switching element S21, S22, S23, . . . S2N−1, S2N, and a second second contact element 4 of the N-tuples in each case can be switchably connected thereto by a second second switching element S21, S22, S23, . . . , S2N−1, S2N, and a third second contact element 4 of the N-tuples in each case can be switchably connected thereto by a third second switching element S21, S22, S23, . . . , S2N−1, S2N, and an N−1th second contact element 4 of the N-tuples in each case can be switchably connected thereto by means of an N−1th second switching element S21, S22, S23, . . . , S2N−1, S2N, and an Nth second contact element 4 of the N-tuples in each case can be switchably connected thereto by means of an Nth second switching element S21, S22, S23, . . . , S2N−1, S2N, wherein N is a natural number that is greater than or equal to 2.

Accordingly, each first heating element 2 of the N heating elements 2 of the N-tuples can be switchably connected by its second contact element 4 through the first second switching element S21, S22, S23, . . . , S2N−1, S2N to the second voltage connection element 7, and each second heating element 2 of the N heating elements 2 of the N-tuples can be switchably connected by its second contact element 4 through the second second switching element S21, S22, S23, . . . , S2N−1, S2N to the second voltage connection element 7, and each third heating element 2 of the N heating elements 2 of the N-tuples can be switchably connected by its second contact element 4 through the third second switching element S21, S22, S23, . . . , S2N−1, S2N to the second voltage connection element 7, etc., etc., and each N−1th heating element 2 of the N heating elements 2 of the N-tuples can be switchably connected by its second contact element 4 through the N−1th second switching element S21, S22, S23, S2N−1, S2N to the second voltage connection element 7, and each Nth heating element 2 of the N heating elements 2 of the N-tuples can be switchably connected by its second contact element 4 through the Nth second switching element S21, S22, S23, . . . , S2N−1, S2N to the second voltage connection element 7, wherein N is a natural number that is greater than or equal to 2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electric heating device comprising:
a plurality of electric heating elements, each of the plurality of electric heating elements have a first electric contact element and a second electric contact element and at least one heater, the first and second electric contact elements electrically contacting the at least one electric heater;
a first voltage connection element and a second voltage connection element; and
first switching elements and second switching elements,
wherein pairs of two electric heating elements are each wired such that two first electric contact elements of the two electric heating elements are adapted to be switchably connected to the first voltage connection element by one of the first switching elements, and
wherein one of the second contact elements of the pairs of the two electric heating elements are adapted to be switchably connected to the second voltage connection element via a second switching element, and the other second contact element of the pair is adapted to be switchably connected thereto by a different second switching element.

2. The electric heating device according to claim 1, wherein each first heating element of the two heating elements of the pairs are adapted to be switchably connected by its second contact element through one second switching element to the second voltage connection element and each second heating element of the two heating elements of the pairs is adapted to be switchably connected by its second contact element through the other second switching element to the second voltage connection element.

3. The electric heating device according to claim 1, wherein a third heating element is associated with the pairs having two electric heating elements so that triplets of heating elements are present, wherein the triplets of three electric heating elements are each wired such that three first electric contact elements of the three electric heating elements are adapted to be switchably connected to the first voltage connection element by one of the first switching elements and one of the second contact elements of the triplets is adapted to be switchably connected to the second voltage connection element via a first second switching element, wherein a second second contact element of the triplets is adapted to be switchably connected thereto by a second second switching element, and wherein a third second contact element of the triplets is adapted to be switchably connected thereto by a third second switching element.

4. The electric heating device according to claim 3, wherein each first heating element of the three heating elements of the triplets is adapted to be switchably connected by its second contact element through one second switching element to the second voltage connection element, and each second heating element of the three heating elements of the triplets is adapted to be switchably connected by its second contact element through the second second switching element to the second voltage connection element, and each third heating element of the three heating elements of the triplets is adapted to be switchably connected by its second contact element through the third second switching element to the second voltage connection element.

5. The electric heating device according to claim 1, wherein N−2 heating elements are associated with the pairs having two electric heating elements so that N-tuples of heating elements are present, wherein the N-tuples of N electric heating elements are each wired such that N first electric contact elements of the N electric heating elements are adapted to be switchably connected by one of the first switching elements to the first voltage connection element, and wherein one first second contact element of the N-tuples is adapted to be switchably connected to the second voltage connection element via a first second switching element, and wherein a second second contact element of the N-tuples is adapted to be switchably connected thereto by a second second switching element, and wherein a third second contact element of the N-tuples is adapted to be switchably connected thereto by a third second switching element, and wherein an nth second contact element of the N-tuples is adapted to be switchably connected thereto by an nth second switching element, and wherein an N−1th second contact element of the N-tuples is adapted to be switchably connected thereto via an N−1th second switching element, and wherein an Nth second contact element of the N-tuples is adapted to be switchably connected thereto via an Nth second switching element, and wherein N is a natural number that is greater than or equal to 2 and n is a natural number from 4 to N−2.

6. The electric heating device according to claim 5, wherein each first heating element of the N heating elements of the N-tuples is adapted to be switchably connected by its second contact element through the first second switching element to the second voltage connection element, and wherein each second heating element of the N heating elements of the N-tuples is adapted to be switchably connected by its second contact element through the second second switching element to the second voltage connection element, and each third heating element of the N heating elements of the N-tuples is adapted to be switchably connected by its second contact element through the third second switching element to the second voltage connection element, and each N−1th heating element of the N heating elements of the N-tuples are adapted to be switchably connected by its second contact element through the N−1th second switching element to the second voltage connection element, and each Nth heating element of the N heating elements of the N-tuples is adapted to be switchably connected by its second contact element through the Nth second switching element to the second voltage connection element, and wherein N is a natural number that is greater than or equal to 2.

7. The electric heating device according to claim 1, wherein the electric switching elements are electronically controllable switching elements.

8. The electric heating device according to claim 7, wherein the electric switching elements are electronically controllable power switching elements.

9. The electric heating device according to claim 7, wherein the electric switching elements are part of an electronic control unit that is a component of the electric heating device.

10. The electric heating device according to claim 1, wherein radiator elements are provided and are arranged in thermal contact with the electric heating elements for heat transfer from the electric heating elements to a medium flowing around and/or through the radiator elements.

11. The electric heating device according to claim 1, wherein the radiator elements are arranged such that at least one radiator element is arranged adjacent to one of the electric heating elements.

12. A method for operating an electric heating device according to claim 1, the method comprising:
selectively controlling the first switching elements; and
selectively controlling the second switching elements;
wherein the first and second switching elements are selectively controlled in order to heat the electric heating elements in a controlled manner.

13. The method according to claim 12, wherein the first switching elements and/or the second switching elements are controlled in order to heat each heating element in an individually controlled manner.
